(19) United States
(12) Patent Application Publication
(10) Pub. No.: US 2010/0008264 A1
(43) Pub. Date: Jan. 14, 2010

(54) METHOD AND APPARATUS FOR FACILITATING INSTALLATION OF PACKET-SWITCHED TELEPHONY EQUIPMENT ON A SUBSCRIBER PREMISES

(75) Inventors: David L. Ellis, Lilburn, GA (US); Yucheng Jin, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/170,417

(22) Filed: Jul. 9, 2008

(51) Int. Cl. H04L 12/16

(52) U.S. Cl. 370/259

(57) ABSTRACT

A residential gateway provides packet-switched telephony service over a broadband communications network. The gateway includes data terminal equipment having an interface for communicating with customer premises equipment. The gateway also includes a self-installation agent for generating signals that are rendered as audio prompts that guide a user through a process for installing the residential gateway so that packet-switched telephony services are available to the user through the customer premises equipment.

### FIELD OF THE INVENTION

This invention relates generally to the provision of real-time services over a packet network, and more particularly to the provision of Internet telephony to transport voice and data over an HFC network.

### BACKGROUND OF THE INVENTION

Today, access to the Internet is available to a wide audience through the public switched telephone network (PSTN). Typically, in this environment, a user accesses the Internet though a full-duplex dial-up connection through a PSTN modem, which may offer data rates as high as 56 thousand bits per second (56 kbps) over the local-loop plant.

However, in order to increase data rates (and therefore improve response time), other data services are either being offered to the public, or are being planned, such as data communications using full-duplex cable television (CATV) modems, which offer a significantly higher data rate over the CATV plant than the above-mentioned PSTN-based modem. Services being offered by cable operators include packet telephony service, videoconference service, T1/frame relay equivalent service, and many others.

Various standards have been proposed to allow transparent bi-directional transfer of Internet Protocol (IP) traffic between the cable system headend and customer locations over an all-coaxial or hybrid-fiber/coax (HFC) cable network. One such standard, which has been developed by the Cable Television Laboratories, is referred to as Interim Specification DOCSIS 1.1. Among other things, DOCSIS 1.1 specifies a scheme for service flow for real-time services such as packet telephony (“Voice over IP” or “VoIP”). Packet telephony may be used to carry voice between telephones located at two endpoints. Alternatively, packet telephony may be used to carry voice-band data between endpoint devices such as facsimile machines or computer modems.

Voice over IP telephony allows individuals in different locations to communicate with each other over an IP network, just as users have traditionally communicated over voice telephones using Public Switched Telephone Networks (PSTN). In addition to voice, IP telephony may include a combination of video, still image, and data information during a communication session. Broadband networks such as HFC networks, xDSL networks and the like are providing telephony services using, for instance, the Voice Over Internet Protocol (VoIP) and the Data Over Cable Service Interface Specification (DOCSIS). Operators of such networks may want to provide services having the same or higher level of availability as that of the competing Local Exchange Carrier (LEC) or other telephony service provider. When using IP to carry voice, some connections can stay on the IP network while others must connect to the public switched telephone network (PSTN) to allow calls to non-IP subscribers.

One problem that arises when provisioning VoIP services is the need for a VoIP adapter (e.g., a Media Terminal Adapter or MTA) to be installed at the subscriber premises by trained personnel since subscribers, such as individual homeowners and small business owners, are not often knowledgeable of proper installation techniques. Not only is such a visit by trained service personnel expensive for the telephone company, but it often involves scheduling between the subscriber and the service provider. Difficulties arising from such required scheduling are well recognized by all parties involved and can be a major source of inconvenience, especially to the subscriber who must often take time off from work or other scheduled events to be at the premises for the appointment time.

### BRIEF DESCRIPTION OF THE DRAWING

FIG. 1 shows an illustrative voice-over-IP communications system.

FIG. 2 shows one example of an MTA that may be employed in the voice-over-IP communications system of FIG. 1 and which includes a self-installation agent.

FIG. 3 is a flowchart showing one example of a simplified installation process that may be performed by a subscriber with the assistance of the self-installation agent in the MTA.

### DETAILED DESCRIPTION

As detailed below, an apparatus and method is provided that allows a subscriber to install VoIP equipment at the subscriber premises without assistance from trained service personnel, thus avoiding dispatch of trained personnel. Subscriber installable equipment could be shipped to the subscriber, thereby completely eliminating the dispatch of trained service personnel, not to mention the significant increase in convenience to the subscriber who may then install the VoIP equipment at a convenient time.

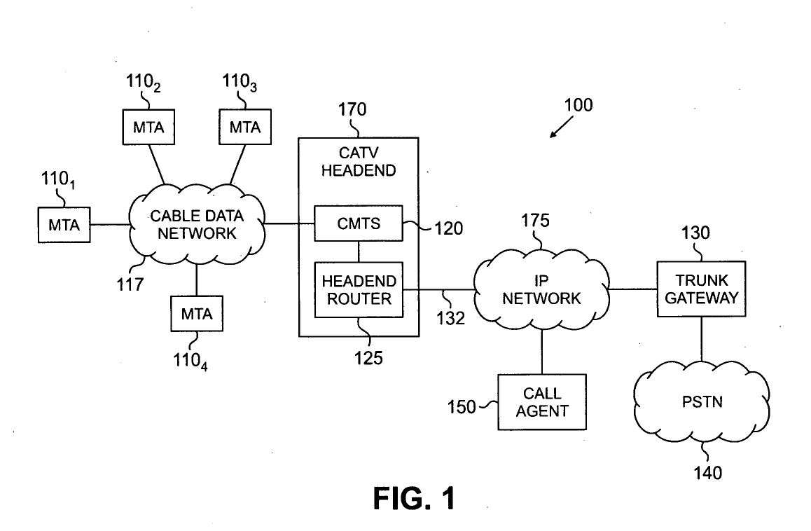

An illustrative broadband access network 100 is shown in FIG. 1. The broadband access network 100 is representative of a network architecture in which subscribers associated with subscriber or residential gateways such as embedded multi-media terminal adapters (eMTAs) or stand-alone multi-media terminal adapters (sMTAs) may access the Internet or other IP network 175 and a Public Switched Telephone Network (PSTN) 140. In particular, MTAs 110₁-110₄ are in communication with the IP network 175 via a CATV network. Cable TV network access or IP TV network access is provided by an MSO (Multi-Service Operator) (not shown). In this context, it is assumed the MSO provides (besides the traditional CATV, or more recently, through Internet Protocol TV, access network facilities exemplified by communications network 117) CATV head-end 170 and a cable modem employed by the MTAs. This CATV network arrangement is also referred to herein as a cable data network. CATV network is typically an all-coaxial or a hybrid-fiber/coax (HFC) cable network. MTAs 110₁-110₄ are also in communication with PSTN 140 via the cable network, IP network 175, and trunk gateway 130. Of course, other broadband access networks such as xDSL (e.g., ADSL, ADLS2, ADSL2+, VDSL, and VDSL2) may also be employed. In some of these access networks the MTA is sometimes referred to as an analog telephony adaptor (ATA).

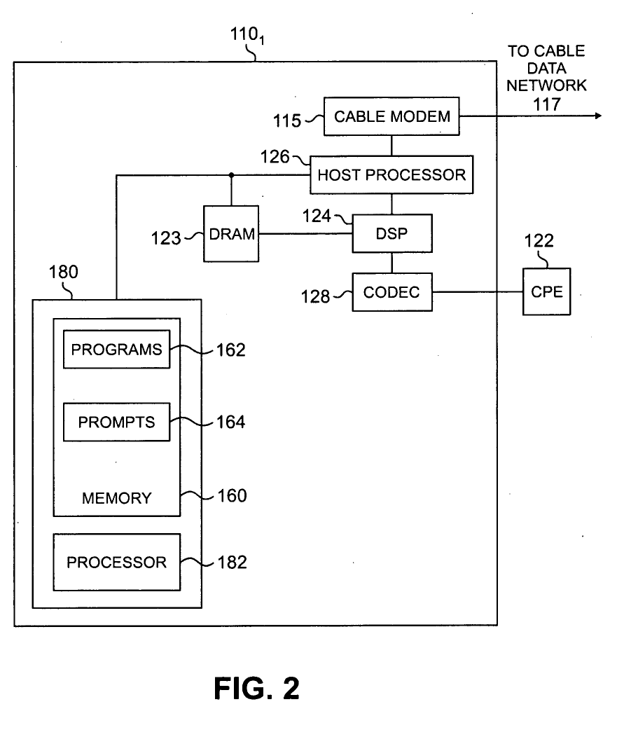

As shown in FIG. 2 for residential gateway or MTA 110₁, the MTAs 110₁-110₄ include a CODEC 128, a Digital Signal Processor (DSP) 124, host processor 126 and Cable Modem (CM) 115. CODEC 128, DSP 124, and host processor 126 are collectively representative of data terminal equipment, which is coupled to the communications network 117 of FIG. 1 via CM 115 to provide communications services to a user of telephone 122. CM 115 provides the access interface to the cable data network via an RF connector and a tuner/amplifier (not shown). Broadly speaking, DSP 124 generates data packets from the analog signals received from the telephone 122. That is, DSP 124 and CODEC 128 collectively perform all of the voice band processing functions necessary for delivering voice and voice-band data over a cable network, including echo cancellation, packet loss concealment, call progress tone generation, DTMF/pulse and fax tone detection, audio compression and decompression algorithms such as G.723 and G.729, packet dejittering, and IP packetization/depacketization. Typically, DSP 124 encodes the data with pulse code modulated samples digitized at rates of 8, 16 or 64 kHz. Host processor 126 receives the data packet from the DSP 124 and adds an appropriate header, such as required by the MAC, IP, and UDP layers. Once the packet is complete, it is sent to CM 115, where it remains in a queue until it is transmitted over the cable data network to the CMTS 120 in the CATV headend 170. For the purposes of the present invention, the service being provided is assumed to be a real-time service such as packet telephony. Accordingly, the data packets should be formatted in accordance with a suitable protocol such as the Real-Time Transport Protocol (RTP).

In other broadband access networks the CM 115 is replaced with a broadband modem suitable for use with the standards and protocols employed by that network. For example, in an xDSL access network, the functionality of the CM 115 would be performed by an xDSL modem.

An Internet Service Provider (ISP) provides Internet access. In the context of FIG. 1, it is assumed an ISP provides IP network 175, which includes a cable data network access router (not shown) attached to communications link 132. It should be noted that for illustrative purposes only it is assumed that the above-mentioned MSO and ISP Service provider are different entities even though this is not relevant to the inventive concept.

The CM 115 is coupled to the CATV head-end 170 of FIG. 1 via cable network 117, which is, e.g., a CATV radio-frequency (RF) coax drop cable and associated facilities. CATV head-end 170 provides services to a plurality of downstream users (only one of which is shown) and comprises cable modem data termination system (CMTS) 120 and head-end router 125. (CMTS 120 may be coupled to head-end router 125 via an Ethernet 100BaseX connection (not shown).) CMTS 120 terminates the CATV RF link with CM 115 and implements data link protocols in support of the residential service that is provided. Given the broadcast characteristics of the RF link, multiple residential customers and, hence, potentially many home-based LANs may be serviced from the same CMTS interface. Also, although not shown, those of skill in the art will readily appreciate that the CATV network may include a plurality of CMTS/head-end router pairs.

CM 115 and CMTS 120 operate as forwarding agents and also as end-systems (hosts). Their principal function is to transmit Internet Protocol (IP) packets transparently between the CATV headend and the customer location. Interim Specification DOCSIS 1.1 has been prepared by the Cable Television Laboratories as a series of protocols to implement this functionality.

In a full voice-over-Internet communication system, a Call Agent 150 is the hardware or software component that provides the telephony intelligence in the communications system and is responsible for telephone call processing. In particular, Call Agent 150 is responsible for creating the connections and maintaining endpoint states required to allow subscribers to place and receive telephone calls, to use features such as call waiting, call forwarding and the like. In a switched IP communication system, an IP digital terminal connected to a CLASS5 telephony switch substitutes for the Call Agent and trunk gateway. In such a system, IP-based call signaling is conducted between the MTA and IPDT and GR303 or V5.2 call signaling is conducted between IPDT and telephony switch and IP voice traffic is conducted between the MTA and IPDT.

To implement self-installation, MTA 110₁ includes a self-installation agent 180. The self-installation agent 180 facilitates installation of the MTA 110₁ by generating a sequence of audio prompts that can be rendered by any appropriate device such as the customer premises equipment 122 or a speaker that may be incorporated directly into the MTA 110₁, for instance. The self-installation agent includes a processor 182 and a memory 160. Processor 182 is configured to execute instructions and to carry out operations associated with the self-installation agent 180. For example, using instructions retrieved from memory 160, the processor 182 may control the reception and manipulation of input and output data between components of the self-installation agent 180. The processor 182 can be implemented on a single-chip, multiple chips or multiple electrical components. For example, various architectures can be used for the processor 182, including dedicated or embedded processor, single purpose processor, controller, ASIC, and so forth.

Memory 160 may be comprised of any type of computer-readable media, such as ROM, RAM, SRAM, FLASH, EEPROM, or the like. In particular, the memory 160 comprises non-volatile forms of memory such as ROM, Flash, or battery-backed SRAM such that programmed and user entered data is not required to be reloaded in the event of a power failure. Furthermore, the memory 160 may take the form of a chip, a hard disk, a magnetic disk, and/or an optical disk. Memory 160 may be logically (and possibly physically) divided into program memory segment 162 and prompt memory segment 164. It will be appreciated that if the memory segments are physically divided, they need not all be of the same type. For instance, program memory segment 162 may be ROM while prompt memory segment 164 may be Flash or other non-volatile read/write memory in order to more readily allow the stored prompts to be customized. Additionally, each of these memory segments may themselves comprise a mixture of types, for instance either or both memories may include a small amount of RAM for use as transient, or temporary, storage during processing.

For use in guiding the user through the installation process, the program memory segment 162 includes executable instructions that are intended to coordinate the operation of the prompts memory segment 164 and the digital signal processor (DSP) 124 to generate the appropriate audio prompts at the appropriate times so that they can be rendered, for instance, by a speaker in the customer premises equipment 122. In some cases the particular instructions that are executed may be selected based on the user's progress through the installation process. The user's progress may be determined as the MTA 110₁ detects the installation of the various cabling, network interfaces and the like. This information can be communicated to the processor 182, which in turn determines the next sequence of program instructions in memory segment 162 that are to be executed.

Under the direction of the programs in program memory segment 162, DSP 124 reads compressed audio data from the prompts memory segment 164, digitally processes and decompresses the audio data, and transmits the processed data to the CODEC 128. CODEC 128 performs a number of different steps in the self-installation process. For example, the CODEC 128 decodes the audio data received from the DSP 124, which in turn has been retrieved from prompts memory segment 164. The decoded audio data is transformed to an audio signal by the CODEC 128 and output through a speaker in the telephone 122. As previously noted, during a VoIP communication session (after the installation process is complete), CODEC 128 also converts audio received from the customer premises equipment 122 to data and transmits the data to the DSP 124, which in turn digitally processes and compresses (if necessary) the data received from the CODEC 128.

Although MTA 110₁ has been illustrated in FIG. 2 as having various components for discussion purposes, those of skill in the art will appreciate that several components illustrated in MTA 110₁, such as host processor 126, DSP 124, CODEC 128, self-installation agent 180 and cable modem 115 may be implemented in a single programmable processor. Further, in some cases the MTA itself may incorporate a cordless phone base station and handset that includes a speaker to render the audio prompts stored by the user in the MTA.

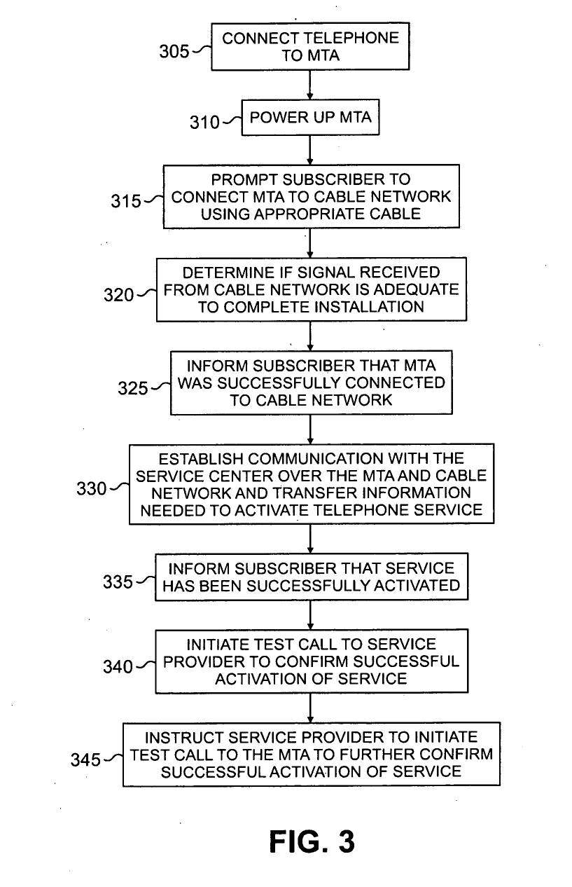

FIG. 3 is a flowchart showing one example of a simplified installation process that may be performed by a subscriber with the assistance of the self-installation agent in the MTA. As a preliminary matter, in step 305 the subscriber connects a telephone to the MTA using an appropriate cable that may have been provided along with the MTA. In this example the telephone is assumed to have a speaker through which the audio prompts will be rendered. Next, in step 310, the subscriber powers up the MTA, thereby initializing the self-installation agent so that it can begin guiding the subscriber through the installation process. The first prompt that is presented in step 315 directs the subscriber to attach one end of a cable to a designated port on the MTA and the other end to the subscriber's cable network port or jack. The prompt is accessed and delivered to the telephone speaker under the direction of the executable instructions stored in the memory of the self-installation agent. Next, in step 320 the processor in the self-installation agent determines if the appropriate signal is being received from the cable network at the appropriate signal level. Depending on the result, the processor will cause the executable instructions to issue a prompt in step 325 saying, for instance, that the cable has been successfully connected, or alternatively, that the signal from the telephone company is too weak to continue and that the subscriber should call the for service. Alternatively still, the prompt may provide suggestions such as “assure that the cable connection is not loose,” or, “try another cable jack.” The process can continue in this manner until any other necessary physical connections are successfully made.

The self-installation agent may also automatically perform other tasks that would otherwise normally be performed by the service technician. For instance, the technician would normally call the service center via his or her cell phone to provide them with the MAC address of the MTA and then wait for the service center to confirm the activation of service. The technician may also make a call to and from the subscriber's telephone to ensure that the installation process has been successfully completed.

In the present case, these tasks ordinarily performed by the service technician may be automatically performed by the self-installation agent. Continuing with the flowchart in FIG. 3, in step 330, after all physical connection have been made the processor in the self-installation agent establishes communication with the service center and automatically causes the MAC address to be transferred to the service center over the MTA and the cable network. In step 335 a prompt may be presented informing the subscriber that the service has been successfully activated, or alternatively, that additional information (e.g., billing information) is needed. In step 340 self-installation agent initiates a call from the MTA to the service provider or other party. Finally, in step 345, the self-installation agent instructs the service provider or other party to initiate a test call to the subscriber via the cable network. After performing the test calls, the self-installation process is complete.

Instead of using the self-installation agent to automatically transfer information such as the MAC addresses and the like to the service provider, the self-installation agent may prompt the subscriber to enter this information using the telephone keypad.

One advantage that is provided by the use of a self-installation agent is realized when a subscriber purchases an MTA through a retailer rather than through the subscriber's service provider. Normally, when an MTA is supplied by the service provider, the unit has already been pre-configured and pre-provisioned for that service provider's network so that it is ready to be installed on the subscriber premises with relatively little reconfiguring necessary, thereby simplifying the installation process. On the other hand, if the MTA is purchased from a retailer, the MTA is only minimally configured so that it is compatible with any of a wide variety of different service providers. Accordingly, the installation process may be more complex in a retail environment where the MTA requires more configuring, thereby making the use of a self-installation agent as described herein even more advantageous.

Another advantage provided by the self-installation agent arises from the use of audio prompts, which not only enables the visually impaired to install the MTA but is more convenient for all subscribers since they do not need to be reading text as they go about the installation process.

The steps of the processes described above, which take place on MTA 110, may be implemented in a general, multi-purpose or single purpose processor. Such processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), and/or packetized or non-packetized wireline or wireless transmission signals.

1. A residential gateway for providing packet-switched telephony service over a broadband communications network, comprising:
data terminal equipment having an interface for communicating with customer premises equipment; and
a self-installation agent for generating signals that are rendered as audio prompts that guide a user through a process for installing the residential gateway so that packet-switched telephony services are available to the user through the customer premises equipment.

2. The residential gateway of claim 1 wherein the self-installation agent is configured to communicate the signals to the customer premises equipment for rendering thereon.

3. The residential gateway of claim 1 further comprising a speaker for rendering the signals as audio prompts.

4. The residential gateway of claim 1 further comprising a broadband modem for communicating data between the data terminal equipment and the broadband communications network.

5. The residential gateway of claim 1 wherein the self-installation agent further comprises a first electronic memory segment in which data representative of the audio prompts are stored.

6. The residential gateway of claim 5 wherein the self-installation agent further comprises a second electronic memory segment that stores executable instructions for coordinating the generation of the signals at appropriate times during installation of the residential gateway.

7. The residential gateway of claim 1 wherein the customer premises equipment is a telephone.

8. The residential gateway of claim 1 wherein the data terminal equipment includes a CODEC for converting audio signals to and from audio data and a DSP for processing the audio data, wherein the executable instructions control the operation of the DSP to generate the audio prompts.

9. The residential gateway of claim 1 wherein the packet-switched telephony service is implemented over a connection that conforms to a voice-over-IP protocol.

10. The residential gateway of claim 1 wherein the self-installation agent is configured to determine that a first step in the process has been completed before generating signals that are to be rendered as audio prompts for a second step in the process.

11. The residential gateway of claim 1 wherein the self-installation agent is configured to establish communication with a service provider over the broadband communications network to activate the telephony service.

12. A method of facilitating installation of packet-switched telephony equipment on a subscriber premises, comprising:
generating a first sequence of audio signals that guide a user through a first of a plurality of steps in a process for installing the residential gateway so that packet-switched telephony services are available to the user through customer premises equipment; and
generating a subsequent sequence of audio signals to guide the user through each remaining one of the plurality of steps in the process after each preceding step has been completed.

13. The method of claim 11 further comprising determining that the first step in the process has been completed before generating the subsequent sequence of audio signals.

14. The method of claim 12 wherein the generating steps are performed by the packet-switched telephony equipment.

15. The method of claim 12 further comprising rendering the audio signals with a speaker associated with the packet-switched telephony equipment.

16. The method of claim 12 further comprising rendering the audio signals with a speaker associated with customer premises equipment connected to the packet-switched telephony equipment.

17. The method of claim 12 further comprising establishing communication with a service provider over the packet-switched telephony equipment to activate the telephony service.

18. At least one computer-readable medium encoded with instructions which, when executed by a processor, performs the method of claim 12.
